(19) United States
(12) Patent Application Publication
(10) Pub. No.: US 2026/0217061 A1
(43) Pub. Date: Jul. 30, 2026

(54) PNEUMATIC TYRE

(71) Applicant: Bridgestone Europe NV/SA, Zaventem (BE)

(72) Inventors: Cecilia ANGELOSANTO, Roma (IT); Giuseppe ARNONE, Roma (IT); Marco DEL DUCA, Roma (IT); Antonio TIRONE, Roma (IT)

(21) Appl. No.: 19/141,943

(22) PCT Filed: Dec. 22, 2022
(86) PCT No.: PCT/EP2022/087574

§ 371 Date: Jun. 20, 2025

(51) Int. Cl. B60C 11/12; B60C 11/04

(52) U.S. Cl. CPC B60C 11/1218; B60C 11/04; B60C 2011/1213

(57) ABSTRACT

A pneumatic tyre has a tread band for engaging a road surface at a footprint area of the tyre, shoulder blocks arranged along shoulder circumferential ribs, and central blocks arranged along central circumferential ribs. Four circumferential grooves separate the shoulder ribs and central ribs from each other. The central blocks are separated along their entire axial width by transversal sipes, the transversal sipes defining two endpoints at their respective axially outer ends where they intersect the circumferential grooves.

The present invention relates to a pneumatic tyre.

Recently there has been increasing demand for noise reduction in tyres as a part of the demand for quieter vehicles overall. What is more, with the increasing uptake of electric vehicles with their typically quieter propulsion systems compared to vehicles propelled by internal combustion engines, tyre noise is becoming a more dominant element of the overall vehicle noise. At the same time, there is the demand for tyres with increased wear resistance to prolong the life of the tyre, as well as increased cornering, traction and braking performance.

The present invention aims to provide a tyre which mitigates at least one of the problems associated with existing tyres.

The present invention provides a pneumatic tyre with a tread band for engaging a road surface at a footprint area of the tyre, the tread band comprising:
two shoulder areas at the axially outer ends of the tread band;
a central area identified between the shoulder areas;
a row of shoulder elements arranged along first circumferential ribs in each of the shoulder areas;
at least two rows of central elements arranged along second circumferential ribs in the central area; and
at least three circumferential grooves separating the first and second circumferential ribs from another circumferential rib,
wherein the central elements are separated along their entire axial width by transversal sipes, the transversal sipes defining two endpoints at their respective axially outer ends where they intersect the circumferential grooves.

Here, in the present description, “footprint area” means an outer peripheral surface over an entire circumference of the tyre which comes in contact with a road surface in a case where the tyre is attached to a rim and charged with a predetermined internal pressure is rolled in a state of being charged with a maximum load.

The above “rim” indicates an approved rim in an applicable size (a measuring rim in Standards Manual of ETRTO (The European Tyre and Rim Technical Organisation), and a design rim in Year Book of TRA (The Tire and Rim Association, Inc.)) described or to be described in future in an industrial standard effective in a district where the tyre is produced and used, for example, JATMA Year Book of JATMA (the Japan Automobile Tyre Manufacturers Association) in Japan, Standards Manual of ETRTO in Europe, Year Book of TRA in U.S. or the like (that is, the above “rim” also includes a size that can be included in the above industrial standard in future, in addition to the existing size. Examples of “the size to be described in future” include sizes described as “future developments” in 2013 edition of Standards Manual of ETRTO).

Additionally, “the predetermined internal pressure” indicates an air pressure (a maximum air pressure) corresponding to a maximum load capability of a single wheel in an applicable size and ply rating described in the above Standards Manual of ETRTO or the like. Furthermore, “the maximum load” indicates a load corresponding to the above maximum load capability.

According to the present invention, the central elements are separated along their entire axial width by transversal sipes, the transversal sipes defining two endpoints at their respective axially outer ends where they intersect the circumferential grooves. In comparison to where the central elements are separated by lugs extending substantially in the axial direction of the tyre, the central elements being separated by transversal sipes leads to improved lateral and circumferential connection of the central elements, which results in increased cornering performance and circumferential stiffness (and hence traction and braking performance).

Preferably, an imaginary straight extension line between the two endpoints defines an inclination angle of the transversal sipe with respect to the axial direction of the tyre whose absolute value lies in the range of 25° to 50°, more preferably in the range of 25° to 45°, more preferably in the range of 30° to 40°. The absolute value may be about 35°. The sipe is arranged in this way to improve lateral and circumferential connection of the central elements, which results in increased cornering performance and circumferential stiffness. Also, since the sipe is inclined, it moves into the contact patch of the tyre gradually, in a progressive way, and not over the whole length of the sipe at the same time. This reduces the noise emissions.

Preferably, the imaginary straight extension lines of the transversal sipes in the two rows of central elements are inclined respectively in the opposite direction. This is done to balance the direction and magnitude of transversal force.

Preferably, an extension of the transversal sipes along the axial direction between the two endpoints of the transversal sipes is non-linear. The sipe is arranged in this way to improve lateral and circumferential connection of the central elements, which results in increased cornering performance and circumferential stiffness.

Preferably, the extension along the axial direction between the two endpoints of the transversal sipes is substantially S-shaped. The sipe is arranged in this way to improve lateral and circumferential connection of the central elements, which results in increased cornering performance and circumferential stiffness. This arrangement can also reduce tyre noise by leading to more progressive block impact with the road surface.

Preferably, an undulated profile is superimposed on the S-shaped extension along the axial direction of the transversal sipes. This is the result of the transversal sipes having a three-dimensional shape. (The undulated profile may be visible on the tread surface, or the undulated profile may end a certain distance below the tread surface inside the tread.) This gives a local contact area boost which leads to improved braking; it can also lead to local wear reduction.

Preferably, the transversal sipes have a total length along their extension between the two endpoints and the total length of the transversal sipe having an undulated profile superimposed to the S-shaped extension is at least 20% greater than a transversal sipe extending along a straight line between the two endpoints. This gives the sipe a minimum degree of performance improvement in comparison to a sipe that follows a straight line between the endpoints.

As the undulated profile along the axial direction extends in the radial direction (i.e. in the depth direction of the sipe), another undulated profile may be superimposed on the extension in the radial direction. In this way, the profile is undulated in two directions. Therefore, when a first block moves in the radial direction, it comes into contact with its adjacent second block on the other side of the sipe, which limits the movement of the first block in the radial direction. This increases the above effects of the axial undulated profile further.

Preferably, each endpoint of a transversal sipe of each row of central elements has an offset in the circumferential direction with respect to each circumferential direction closest endpoint of a transversal sipe of the adjacent row or rows. In this way, the endpoints in adjacent rows are not aligned along the tyre axial direction. This leads to reduced tyre noise. Impacts of different endpoints onto the road surface are arranged so that they do not happen all at the same time; if the impact of all endpoints occurred at the same time, the result would be disturbing noise generation.

Preferably, each of the endpoints is offset in the circumferential direction with respect to each circumferential direction closest endpoint of a transversal sipe of each of the rows.

Preferably, the transversal sipes have a radial extension inside the tread band along a radial profile, wherein the radial profile is undulated or zig-zag shaped as the sipes extend in the axial direction.

Preferably, in the footprint area the width in the axial direction of each of the shoulder elements is greater than the width in axial direction of each of the central elements, and wherein over the whole circumference of the tyre the total number of shoulder elements in each row is greater than the total number of central elements in each row. This helps to balance stiffness at the shoulder with stiffness at the centre of the tyre, and to avoid rib “fighting”, and so reduce tyre wear. This arrangement can also reduce tyre noise by reducing synchronization of the impact of the central and shoulder elements with the road surface.

Preferably, the total number of shoulder elements in each row is at most 125% of the total number of central elements in each row, preferably at most 120%, more preferably about 115%.

Preferably, the total number of shoulder elements in each row is at least 110% of the total number of central elements in each row.

In one preferred form, the central elements are void of incisions, and preferably are only separated by the transversal sipes.

Preferably, the shoulder elements are separated by lugs extending substantially in the axial direction of the tyre, and the lugs have a width in the circumferential direction and have along their longitudinal extension a first portion intersecting a circumferential groove and a second portion extending outwards in the axial direction of the tyre

Preferably, the width of the lugs in the first portion intersecting the circumferential groove is smaller than the width of the lugs in the second portion. This helps to reduce the noise produced by impact of the shoulder elements or blocks on the road surface. More specifically this helps to reduce the so called air pumping in the lug generating noise emissions. The tyre noise may be measured using a pass-by noise test. Conversely, the fact that the lugs intersect a circumferential groove means that the adjacent blocks can move with respect to each other as they exit the contact patch of the tyre with the road surface, which leads to wear performance improvement.

Preferably, the width of the first portion is in the range of one-twelfth to one-eighth of the width of the second portion. This helps to reduce the so called air pumping in the lug generating noise emissions.

The width of the first portion may be about 0.4 mm.

Preferably, the sidewalls of the first portion are configured to touch each other when the first portion passes through the contact patch of the tyre with the road surface. In this way, the first portion is closed when it is in the contact patch, which helps to reduce the noise produced by impact of the blocks on the road surface. Conversely, when the blocks are exiting the contact patch, the first portion allows the adjacent blocks to move with respect to each other, which leads to wear performance improvement.

Preferably, the intersection between a lug and a circumferential groove has an offset in the circumferential direction with respect to each circumferential direction closest endpoint of a transversal sipe of each row of the central elements. This arrangement can reduce tyre noise by reducing synchronization of the impact of the central and shoulder elements with the road surface.

Preferably, a lug in each shoulder area is arranged in this way.

In one preferred form, the shoulder elements are void of incisions, and preferably are only separated by the lugs.

A preferred embodiment of the invention will now be described, purely by way of example, with reference to the drawings in which:

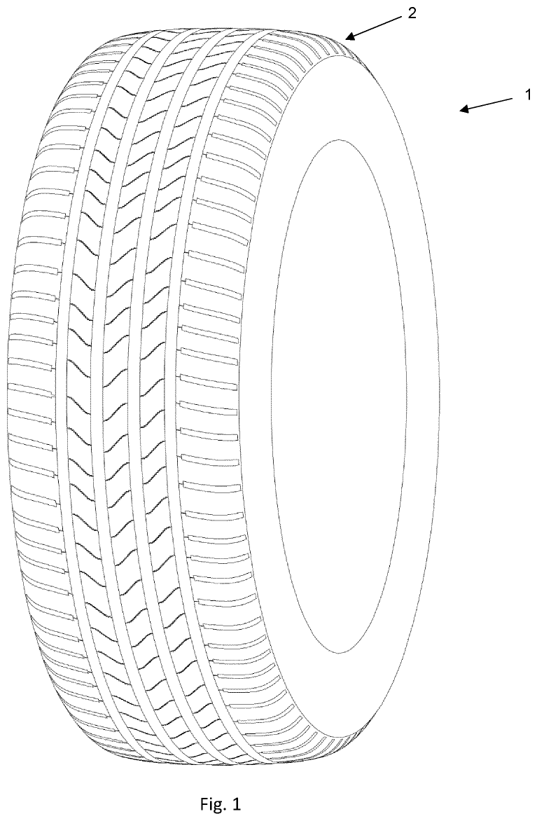

FIG. 1 is a perspective view of the tyre of the preferred embodiment of the invention;

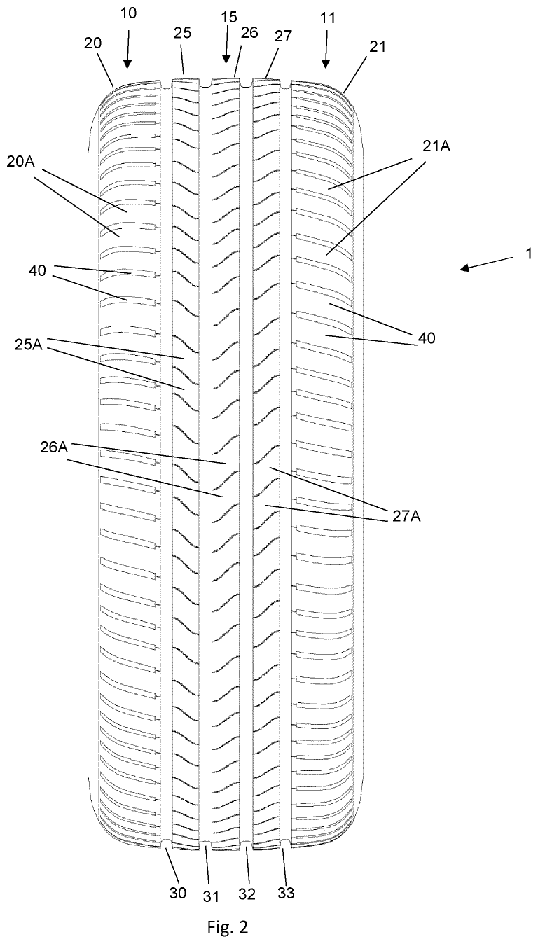

FIG. 2 is a front elevation view of the tyre of FIG. 1;

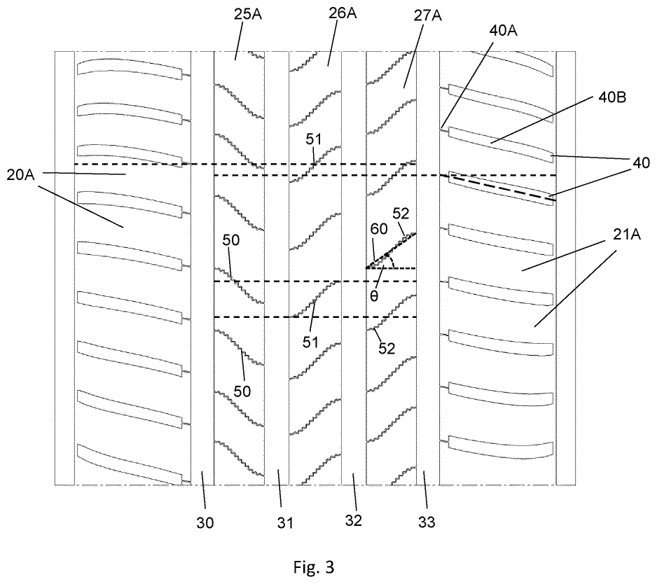

FIG. 3 is a fragmentary front view of the tyre of FIG. 1; and

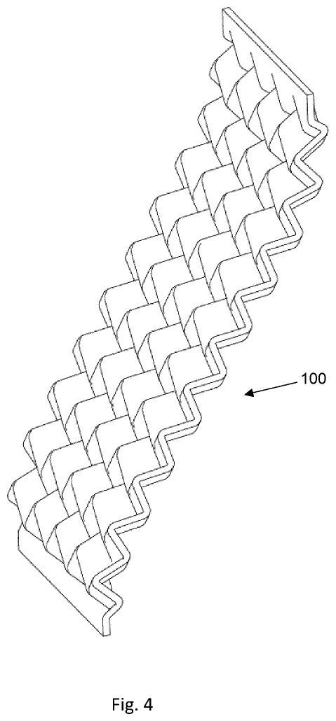

FIG. 4 is a schematic view of a transversal sipe forming portion of a mould for the tyre of FIG. 1.

Referring to FIGS. 1 to 3, a pneumatic tyre 1 is shown. The tyre 1 has a tread band 2 for engaging a road surface at a footprint area of the tyre 1.

As best seen in FIG. 2, the tread band 2 has two shoulder areas 10, 11 at the axially outer ends of the tread band 2, and a central area 15 identified between the shoulder areas 10, 11. The central area includes the tyre equatorial plane.

In each of the shoulder areas 10, 11 is a shoulder (first) circumferential rib 20, 21 which extends along the circumferential direction of the tyre 1. Also in each of the shoulder areas 10, 11 is a row of shoulder elements or blocks 20A, 21A arranged along the shoulder circumferential ribs 20, 21.

In the central area 15 are, in this embodiment, three central (second) circumferential ribs 25, 26, 27 which extend along the circumferential direction of the tyre 1. Also in the central area 15 are, in this embodiment, three rows of central elements or blocks 25A, 26A, 27A arranged along the central circumferential ribs 25, 26, 27.

In this embodiment, the tyre equatorial plane passes through central circumferential rib 26, which is the circumferential rib that is positioned between the other two central circumferential ribs 25, 27.

In this embodiment, the tread band 2 has four circumferential grooves 30, 31, 32, 33 separating the shoulder ribs 20, 21 and central ribs 25, 26, 27 from another circumferential rib 20, 21, 25, 26, 27.

In the footprint area the width in the axial direction of each of the shoulder blocks 20A, 21A is greater than the width in axial direction of each of the central blocks 25A, 26A, 27A.

In addition, over the whole circumference of the tyre 1 the total number of shoulder blocks 20A, 21A in each row is greater than the total number of central blocks central blocks 25A, 26A, 27A in each row. This helps to balance stiffness at the shoulder with stiffness at the centre of the tyre, and to avoid rib “fighting”, and so reduce tyre wear. This arrangement can also reduce tyre noise by reducing synchronization of the impact of the central and shoulder elements with the road surface.

In this embodiment, the tyre 1 has 80 shoulder blocks 20A, 21A in each row, and 70 central blocks 25A, 26A, 27A in each row. However, this is not essential.

The shoulder blocks 20A, 21A are separated by lugs 40 extending substantially in the axial direction of the tyre 1.

As best seen in FIG. 3, the lugs 40 have a width in the circumferential direction and have along their longitudinal extension a first portion 40A intersecting circumferential groove 33 and a second portion 40B extending from the first portion 40A outwards in the axial direction of the tyre 1. The width of the lugs 40 in the first portion 40A is smaller than the width of the lugs 40 in the second portion 40B. In particular, the width of the first portion 40A is small enough that the sidewalls of the first portion 40A are configured to touch each other when the first portion 40A passes through the contact patch of the tyre with the road surface. In this way, the first portion 40A is closed when it is in the contact patch, which helps to reduce the noise produced by impact of the blocks 20A, 21A on the road surface.

The central blocks 25A, 26A, 27A are separated along their entire axial width by transversal sipes 50, 51, 52. The transversal sipes 50, 51, 52 each define two endpoints at their respective axially outer ends where they intersect the circumferential grooves 30, 31, 32, 33.

An imaginary straight extension line 60 between the two endpoints defines an inclination angle θ of the transversal sipe 52 with respect to the axial direction of the tyre 1. The absolute value of angle θ lies in the range of 25° to 50°, and in this embodiment is 35°. The sipe is arranged in this way to improve lateral and circumferential connection of the central elements, which results in increased cornering performance and circumferential stiffness.

In FIG. 3 imaginary straight extension line 60 is shown with respect to a sipe 52 separating central blocks 27A. It can be seen that the sipe 51 which separates central blocks 26A is inclined in the same direction as sipe 52. However, it can be seen that sipe 50, which separates central blocks 25A is inclined in the opposite direction to sipes 51 and 52.

The sipes 50, 51, 52 do not extend in a straight line. This is done to improve lateral and circumferential connection of the central elements, which results in increased cornering performance and circumferential stiffness.

The extension along the axial direction between the two endpoints of the transversal sipes 50, 51, 52 is substantially S-shaped in plan view. The sipe is arranged in this way to improve lateral and circumferential connection of the central elements, which results in increased cornering performance and circumferential stiffness. This arrangement can also reduce tyre noise by leading to more progressive block impact with the road surface.

Furthermore, an undulated profile (in the present embodiment, a zigzagged profile) is superimposed on the S-shaped extension along the axial direction of the transversal sipes 50, 51, 52 in plan view.

In the present embodiment, each endpoint of a transversal sipe 50, 51, 52 of each row of central blocks 25A, 26A, 27A has an offset in the circumferential direction with respect to each circumferential direction closest endpoint of a transversal sipe 50, 51, 52 of the adjacent row or rows. Taking the lower transversal sipe 51 of blocks 26A as an example, it can be seen in FIG. 3 that its endpoints are offset from the closest endpoints of sipes 50 of blocks 25A, and are also offset from the closest endpoints of sipes 52 of blocks 27A. This is shown by the dashed lines. Taking lower transversal sipe 52 of blocks 27A as another example, it can be seen in FIG. 3 that its endpoints are offset from the closet endpoints of sipes 51 which are in the adjacent row. In addition, one of the endpoints of lower sipe 52 (namely, its upper endpoint) is offset from the closest endpoint of upper sipe 50 which is in a non-adjacent row.

The transversal sipes 50, 51, 52 have a radial extension inside the tread band 2 along a radial profile which is undulated or zig-zag shaped as the sipes 50, 51, 52 extend in the axial direction.

In the present embodiment, the central blocks 25A, 26A, 27A are void of incisions, and are only separated by the transversal sipes 50, 51, 52. The central blocks 25A, 26A, 27A also have smooth radially outer surfaces.

In the present embodiment, the intersection between a lug 40 and a circumferential groove 30, 33 has an offset in the circumferential direction with respect to each circumferential direction closest endpoint of a transversal sipe 50, 51, 52 of each row of the central blocks 25A, 26A, 27A. This arrangement can reduce tyre noise by reducing synchronization of the impact of the central and shoulder blocks 25A, 26A, 27A, 20A, 21A with the road surface. Taking the lower lug 40 shown in FIG. 3 as an example, it can be seen that its intersection with circumferential groove 33 is offset from the endpoints of upper sipe 51 of blocks 26A. The intersection of lower lug 40 is also offset from the endpoints of each of the sipes 50, 52 of the other blocks 25A, 27A. In the present embodiment, this is the case for at least some of the lugs 40 in the right shoulder area shown in FIG. 3. This is also the case for at least some of the lugs 40 in the left shoulder area shown in FIG. 3.

As shown in the FIG. 3, the lower lug 40 extends in a substantially straight line. In addition, in this embodiment, although not essential, the inclination angle of the lugs 40 with respect to the axial direction of the tyre is less than the inclination angle of the imaginary straight extension line between the two endpoints of the transversal sipes 50, 51, 52. However, it is not essential that all lugs 40 and all transversal sipes 50, 51, 52 have this relationship, and it is possible that only some of the lugs 40 and transversal sipes 50, 51, 52 have this relationship. In this embodiment, although not essential, the inclination angle of the lugs 40 with respect to the axial direction of the tyre is about 15°.

In this embodiment there are three central circumferential ribs 25, 26, 27, three rows of central blocks 25A, 26A, 27A, and four circumferential grooves 30, 31, 32, 33. However, this is not essential, and the numbers of these ribs, rows and circumferential grooves may vary from this.

FIG. 4 shows a transversal sipe forming portion 100 of a mould for the tyre 1. The shape of the transversal sipe forming portion 100 corresponds to the sipes formed, for example sipes 50, 51 and 52. As can be seen in FIG. 4, as the undulated profile along the axial direction extends in the radial direction (i.e. in the depth direction of the sipe), another undulated profile is superimposed on the extension in the radial direction. In this way, the profile is undulated in two directions.

A preferred embodiment of the invention has been described purely by way of example, and various modifications, additions and/or omissions will present themselves to one skilled in the art, all of which form part of the invention.

1. A pneumatic tyre with a tread band for engaging a road surface at a footprint area of the tyre, the tread band comprising:
two shoulder areas at the axially outer ends of the tread band;
a central area identified between the shoulder areas;
a row of shoulder elements arranged along first circumferential ribs in each of the shoulder areas;
at least two rows of central elements arranged along second circumferential ribs in the central area; and
at least three circumferential grooves separating the first and second circumferential ribs from another circumferential rib, wherein the central elements are separated along their entire axial width by transversal sipes, the transversal sipes defining two endpoints at their respective axially outer ends where they intersect the circumferential grooves.

2. The tyre of claim 1 wherein an imaginary straight extension line between the two endpoints defines an inclination angle of the transversal sipe with respect to the axial direction of the tyre whose absolute value lies in the range of 25° to 50°.

3. The tyre of claim 2 wherein the imaginary straight extension lines of the transversal sipes in the two rows of central elements are inclined respectively in the opposite direction.

4. The tyre of claim 2 wherein an extension of the transversal sipes along the axial direction between the two endpoints of the transversal sipes is non-linear.

5. The tyre of claim wherein the extension along the axial direction between the two endpoints of the transversal sipes is substantially S-shaped.

6. The tyre of claim 5 wherein an undulated profile is superimposed on the S-shaped extension along the axial direction of the transversal sipes.

7. The tyre of claim 6 wherein the transversal sipes have a total length along their extension between the two endpoints and the total length of the transversal sipe having an undulated profile superimposed to the S-shaped extension is at least 20% greater than a transversal sipe extending along a straight line between the two endpoints.

8. The tyre of claim 1 wherein each endpoint of a transversal sipe of each row of central elements has an offset in the circumferential direction with respect to each circumferential direction closest endpoint of a transversal sipe of the adjacent row or rows.

9. The tyre of claim 1 wherein the transversal sipes have a radial extension inside the tread band along a radial profile, wherein the radial profile is undulated or zig-zag shaped as the sipes extend in the axial direction.

10. The tyre of claim 1 wherein in the footprint area the width in the axial direction of each of the shoulder elements is greater than the width in axial direction of each of the central elements, and wherein over the whole circumference of the tyre the total number of shoulder elements in each row is greater than the total number of central elements in each row.

11. The tyre of claim 10 wherein the total number of shoulder elements in each row is at most 125% of the total number of central elements in each row, preferably at most 120%, more preferably about 115%.

12. The tyre of claim 1 wherein the central elements are void of incisions and are only separated by the transversal sipes.

13. The tyre of claim 1 wherein the shoulder elements are separated by lugs extending substantially in the axial direction of the tyre, and wherein the lugs have a width in the circumferential direction and have along their longitudinal extension a first portion intersecting a circumferential groove and a second portion extending outwards in the axial direction of the tyre.

14. The tyre of claim 13 wherein the width of the lugs in the first portion intersecting the circumferential groove is smaller than the width of the lugs in the second portion.

15. The tyre of claim 14 wherein the width of the first portion is in the range of one-twelfth to one-eighth of the width of the second portion.

16. The tyre of claim 13 wherein the sidewalls of the first portion are configured to touch each other when the first portion passes through the contact patch of the tyre with the road surface.

17. The tyre of claim 13 wherein the intersection between a lug and a circumferential groove has an offset in the circumferential direction with respect to each circumferential direction closest endpoint of a transversal sipe of each row of the central elements.

18. The tyre of claim 1 wherein the shoulder elements are void of incisions and are only separated by the lugs.
